(19) United States
(12) Patent Application Publication
(10) Pub. No.: US 2014/0193259 A1
(43) Pub. Date: Jul. 10, 2014

(54) OFFSHORE WIND TURBINE GENERATOR CONNECTION ARRANGEMENT AND TOWER SYSTEM

(71) Applicant: Eystein Borgen, Radal (NO)

(72) Inventor: Eystein Borgen, Radal (NO)

(73) Assignee: SWAY AS, Bergen (NO)

(21) Appl. No.: 13/983,461

(22) PCT Filed: Feb. 3, 2012
(86) PCT No.: PCT/NO12/00014

§ 371 Date: Mar. 18, 2014

Related U.S. Application Data
(60) Provisional application No. 61/438,989, filed on Feb. 3, 2011.

(51) Int. Cl. F03D 11/04

(52) U.S. Cl. CPC F03D 11/04
USPC 416/85; 29/897.33

(57) ABSTRACT

An offshore wind turbine generator comprises an elongated, buoyant tower, having an internal service tube, the service tube extending from the lower end of the tower to above the waterline when in use, a connection arrangement comprising an upper connection assembly, and a lower connection assembly. An intermediate tension/torsion leg is arranged between the upper and lower connection assemblies. The connection assembly is adapted for lowering and raising within the service tube.

### BACKGROUND

1. Field of the Invention

The present invention relates to wind turbine generators, more specifically to floating, offshore wind turbine generators.

2. Brief Description of the Prior Art

The development of wind turbine generators for generating power, preferably in the form of electric power, has moved steadily in the direction of larger wind turbines. Wind turbine generators with an output of about 5 MW and a rotor diameter of more than 115-125 m have now been designed and constructed. Wind turbine generators as large as 5 MW and more have been designed primarily with a view to being installed offshore due to a variety of technical, logistical and aesthetic considerations.

Offshore wind turbine generators are in general either of the fixed installation type, or the floating type. The floating type of wind turbine generator presents a significant number of technical challenges in terms of installation, operation and maintenance. Such wind turbine generators are inherently large constructions, and often extend very far beneath the surface. The area where the wind turbine generator is constructed may be much shallower than the intended installation location. As a result, it is often necessary to tow the wind turbine generator horizontally to its destination, up-right the wind turbine generator and anchor it to the seabed, each phase of which presents its own technical difficulties due in part to the shear size of the wind turbine generator.

It is also necessary to pre-install the anchor(s) for floating wind turbines.

There is not presently known an adequate integrated solution to such challenges.

In addition, once installed, a floating wind turbine generator will be subjected to strong winds that will cause both pitching and yawing motions of the wind turbine generator tower. Such forces cause strain on the tower itself, as well as exposing such components as the electrical cables, the anchor attachment etc to possible failure. These forces can in fact be exacerbated by the torque caused by the rotation of the turbine itself. Known floating wind turbine generators do not provide adequate arrangements for efficiently compensating for pitch and yaw.

Once installed, offshore wind turbine generators will require periodic maintenance of the above-water components such as the turbine and blades, the under-water components such as the anchoring arrangement and pitch/yaw compensating elements as well as internal components such as electrical connections, motorized components, rotation-facilitating elements etc. There exits a need for an arrangement in offshore wind turbine generators that facilitate such maintenance operations.

### SUMMARY OF THE INVENTION

It is an object of the present invention to provide a solution to the above-described shortcomings and existing needs in the prior art.

According to one aspect of the invention is provided an offshore wind turbine generator comprising an elongated, buoyant tower, having an internal service tube, the service tube extending from the lower end of the tower to above the waterline when in use, a connection arrangement comprising an upper connection assembly, and a lower connection assembly, an intermediate tension/torsion leg being arranged between the upper and lower connection assemblies; wherein the connection assembly is adapted for lowering and raising within the service tube.

According to another aspect of the invention is provided an offshore wind turbine generator comprising an elongated, preferably substantially cylindrical buoyant tower, having an internal service tube, the service tube extending from the lower end of the tower to above the waterline when in use, a connection arrangement, movably arranged within the service tube, the connection arrangement comprising an upper connection assembly comprising a universal joint and yaw-assembly, said upper connection assembly being arranged to rotatably seat in the lower end of the service tube, a lower connection assembly comprising a universal joint and anchor connector, a tension/torsion leg arranged between the upper and lower connection assemblies, an anchor having a coupling for receiving the anchor connector and a winch positioned in the tower for lowering and raising the connection assembly within the service tube. This arrangement can be lowered into place during installation, and raised later for maintenance for example. The connection arrangement can be provided with sufficient buoyancy to almost neutralize the weight in water of the connection arrangement so that only a small winch will be required during installation and maintenance.

According to another aspect of the invention the anchor is a suction anchor and is connected to the connection assembly during transport and installation of the wind turbine generator. The anchor is attached to the lower end of the wind turbine generator tower by hydraulically-actuated locking pins.

According to another aspect of the invention, the universal joint and yaw assembly of the upper connection assembly comprises a ring-shaped member connected to a rocker arm of the universal joint. The ring-shaped member has a slanting lower circumferential surface. The slanting surface is arranged to rotatably seat against a wedge-shaped plain bearing located at the lower end of the service tube. The two opposing faces of the wedge-shaped member have different angles. The inner-facing surface (the surface against which the slanting surface of the ring-shaped element slides) has a greater degree of slope from vertical than the opposite surface (the surface abutting against the inside of the service tube). The difference in angles ensures that the wedge shaped member is pressed securely in place against the service tube, while allowing the ring-shaped element to slide against it. A retainer ring ensures that the wedged shaped plain bearing can be retraced to surface for repair/replacement together with the universal joint and yaw assembly. The reaction torque is carried by the tension/torsion leg down to the seabed via the fixed anchor. This arrangement results in a passive “clutch”, with the holding torque being a function of the net buoyancy of the tower (up-lift force when installed), the friction coefficient in the sliding surface, the angle to vertical of the wedged shaped member inner surface and the radius of the ring shaped element. The yaw arrangement is preferable mounted at the lower end of the tower or service pipe but it can also be conceived to mount the yaw assembly in air at the upper end of the service pipe. In this case the tension leg must be extended inside the service pipe and the upper universal joint, which still has to be positioned at the lower end of the tower, would be separated from the yaw system. Cable conduits are arranged in the space between the ring-shaped element and the universal joint. Torsion stiff electrical cables from the turbine pass down the service tube, through these conduits, exiting the bottom of the tower. At the upper end of the service tube the electrical cables are connected to a swivel and electrical slip ring connection. Thereby, the entire tower will be allowed to rotate (yaw), while the upper connection assembly, the tension leg, the anchor and the electrical cables in the service tube remain stationary with respect to the seabed.

According to another aspect of the invention the intermediate tension leg has an elongated portion of greater diameter in the form of an air, foam or gas filled bouyancy chamber.

According to another aspect of the invention, the wind turbine generator tower has solid ballast, or a combination of solid and water ballast. In one embodiment, solid ballast is arranged in the lower end of the tower, while water ballast is arranged at an upper level in the tower during horizontal towing of the tower. The tower is righted by shifting the water ballast to a lower level of the tower. According to another aspect of the invention, solid ballast such as sand, cement or the like can be added to the tower while the tower is in a vertical orientation. According to this aspect, the ballast is poured into the service tube, and allowed to fall toward the bottom of the tower. A plug, trap door or other temporary blockage blocks the lower part of the service tube. Directly above the blockage is arranged one or more openings in the wall of the service tube, leading to a ballast chamber. The solid ballast will thus fall to the lower part of the service tube, encounter the temporary blockage, and be led into the ballast chamber. The blockage may advantageously be slanted towards the openings in the wall. After the ballast is filled, the blockage may be removed to restore the normal functionality of the service tube.

According to yet another aspect of the invention, the upper end of the tower, directly adjacent to the attachment point for the turbine, is offset at an angle from the vertical axis of the tower. This offset is arranged to compensate for the yaw forces caused by the rotation of the turbine blades. Such yaw forces are due to the fact that the axis of the turbine shaft, which is transferring the torque from the rotor, and the axis of the tower are not perpendicular. This angle is typically some 4-6 degrees from being perpendicular. The effect is that some of the torque in the shaft will be transferred to the tower top as a torque component (or yawing moment) around the tower's longitudinal axis. To compensate for this yawing moment the rotor is placed off axis of the tower so that the thrust forces acting on the rotor multiplied by the lever arm (the off axis distance) will create a yawing moment fully or partly counteracting the yaw moment component from the shaft torque. The effect is that the yaw moment caused by the shaft torque is fully or partly cancelled out and the holding torque in the yaw clutch at the bottom of the tower can be made with a smaller diameter. This also has the effect that the service pipe can be made of a smaller diameter to accommodate the clutch during hoisting of the connection arrangement for installation and maintenance purposes.

### BRIEF DESCRIPTION OF THE DRAWINGS

FIG. 1 is a perspective view of an embodiment of a floating offshore wind turbine generator

FIG. 2 is a front elevational view of an embodiment of a floating offshore wind turbine generator similar to the embodiment from FIG. 1, but with an offset upper end.

FIG. 3 is a side sectional view of the tower section of the wind turbine generator, showing a moveable connection arrangement in its pre-installation position inside the service tube.

FIG. 4 is a side elevational view of the tower, with the moveable connection arrangement in an intermediate position.

FIG. 5 is a side elevational view of the tower, with the moveable connection arrangement in a lowered position.

FIG. 6 is a side sectional view of the tower, with the moveable connection arrangement in a raised position above the water line

FIG. 7 is a sectional view of the buoyancy chamber of the tension leg, also showing the yaw assembly and anchor locking pins.

FIG. 8 is an illustration of the wind turbine generator showing ballast compartments

FIG. 9 is a sectional view of the wind turbine generator tower showing ballast compartments

FIG. 10 is a sectional detail view of the upper connection assembly according to one embodiment of the invention

FIG. 11 is an exploded view of the yaw assembly

FIG. 12 is a detailed sectional view of the plain bearing arrangement of the yaw assembly

FIG. 13a and b is a view of an alternate embodiment of the lower end of the tower

FIGS. 14 is a view of the yaw assembly, employed in the alternate embodiment of the lower end of the tower.

FIG. 15a, b and c are detail view of the upper universal joint

FIG. 16 is a sectional view of the upper connection assembly

FIG. 17a and b are views of the cable support frame

FIGS. 18a and b are view of the friction ring

FIG. 19a and b are detailed views of the upper universal joint

FIG. 20a is a side elevational view of the anchor attached to the bottom of the tower.

FIG. 20b is a side elevational view of the anchor, showing the extension that comprise holes for the locking pins.

FIGS. 21-23 show views of a cable connection arrangement

FIG. 24 shows an off-set angle of an upper end of the tower

### DETAILED DESCRIPTION OF THE INVENTION

A preferred embodiment of the invention will now be described with reference to the drawings.

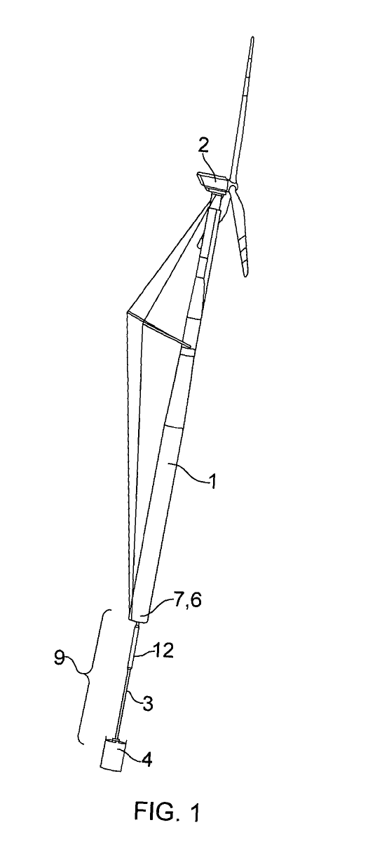

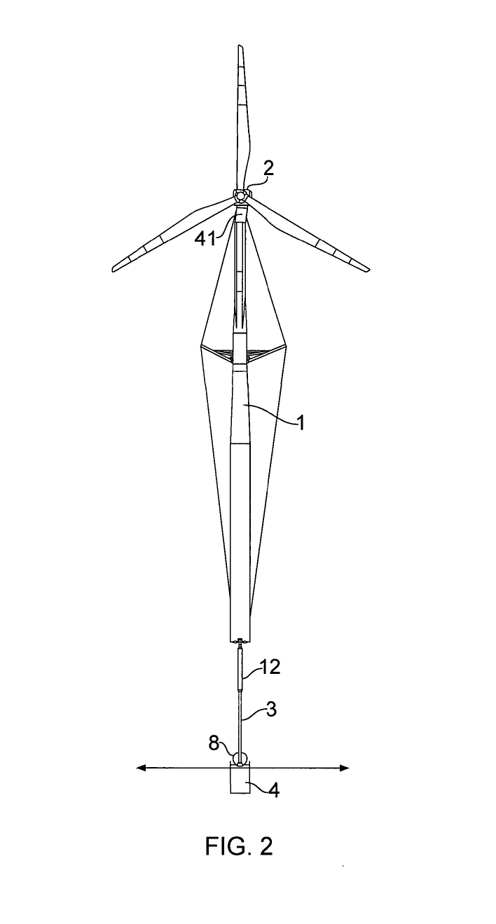

According to a preferred embodiment, the present invention is an offshore floating wind turbine generator comprising a 186-metre floating tower 1, of which 90 meters raises above sea level and 96 meters plunge into the ocean. A wind turbine 2 is mounted atop the floating tower. The floating tower 1 is anchored to the seabed by a tension leg 3 and an anchor, preferably a suction anchor 4 as shown in FIGS. 1 and 2. The tension leg is arranged to also resist torsion moments (torque) and has the form of a hollow pipe. An upper connection assembly 5 comprising an upper universal joint 6 and a yaw assembly 7 are arranged at the upper end of tension leg 3, while a lower universal joint 8 is arranged at the lower end of tension leg 3 at a connection point with the anchor 4. FIG. 1 further illustrates the wind direction, and an arrangement with spreader beams and tension cables for provide structural strength of the tower under forces caused by the wind.

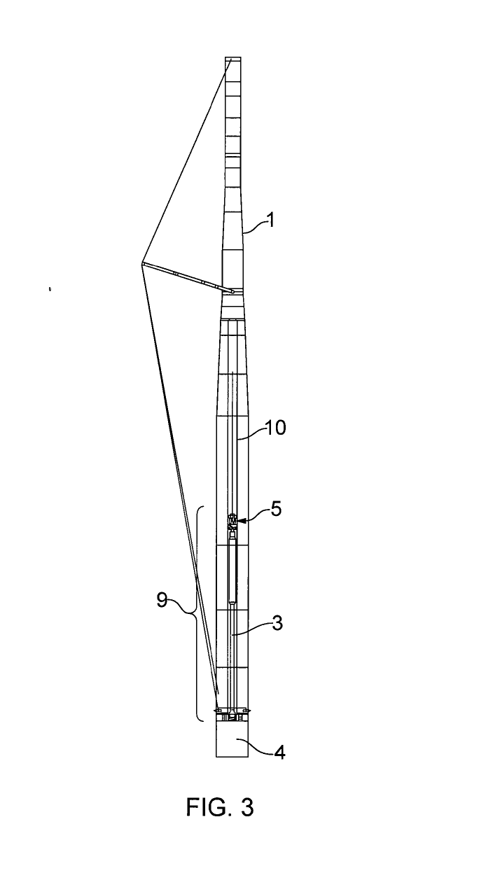

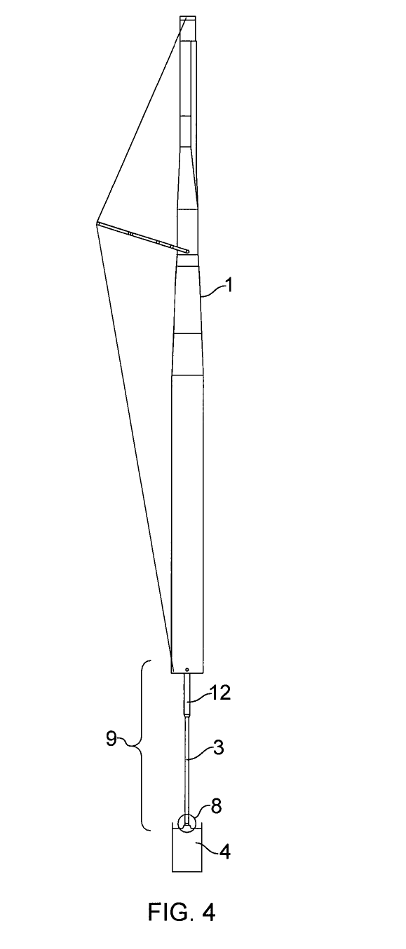

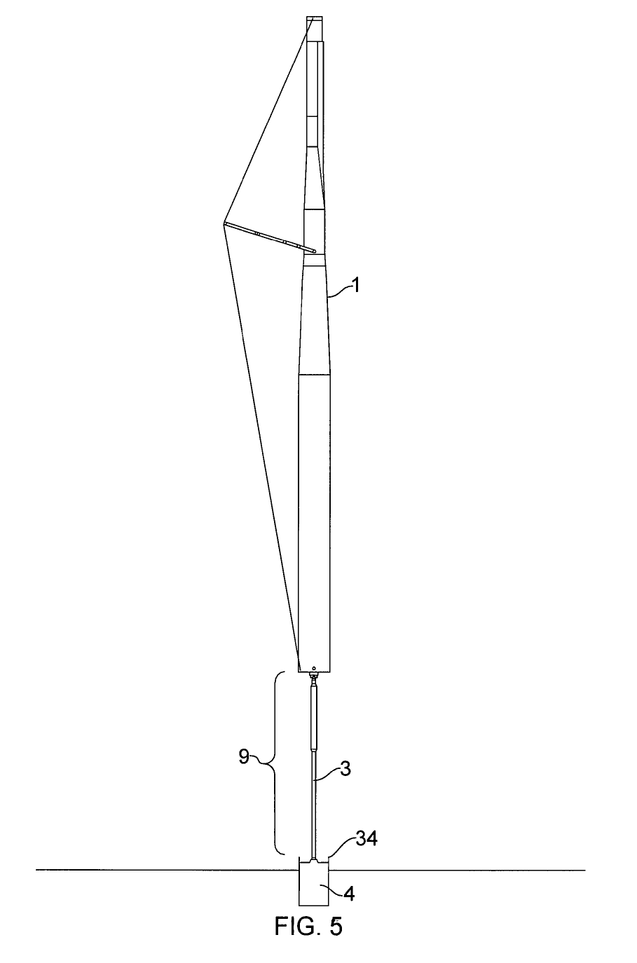

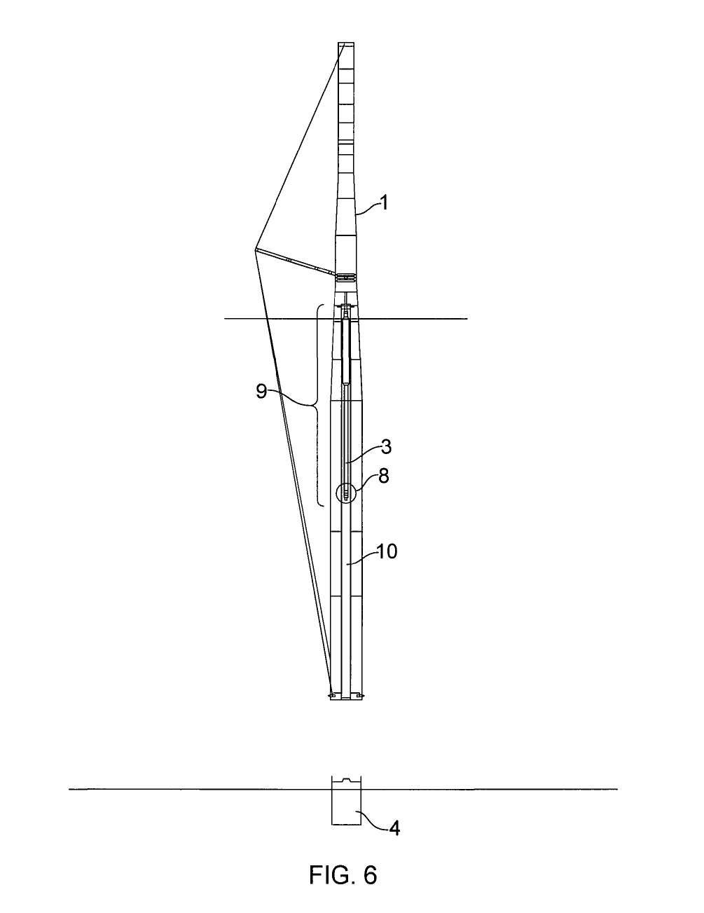

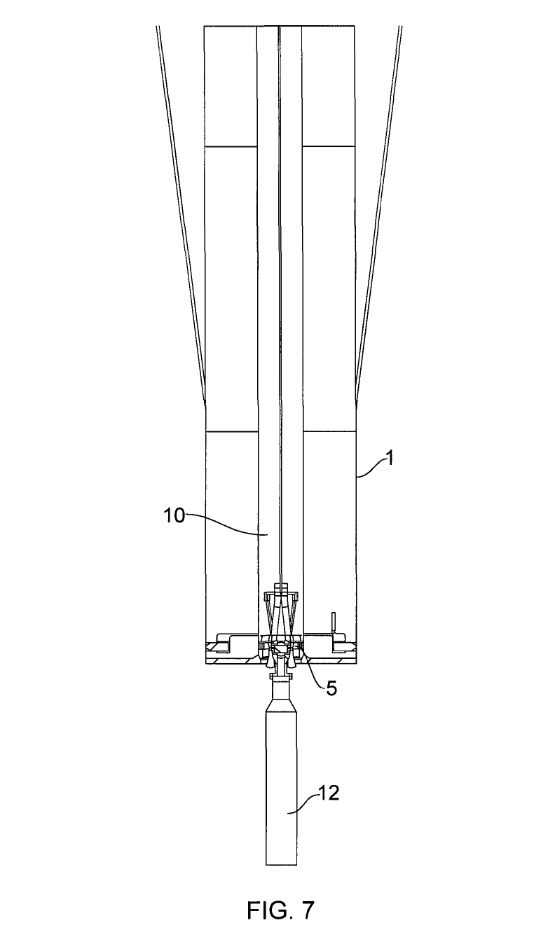

As shown in FIGS. 3-6, one aspect of the invention comprises a movable connection assembly 9. The moveable connection assembly 9 comprises the upper connection assembly 5, the tension leg 3 and the anchor 4, movably arranged in a service tube or pipe 10 arranged axially within the hollow interior of tower 1. A winch 11 positioned within the tower is used to raise and lower the moveable connection assembly 9 within the service tube. As shown in FIG. 3, the moveable connection assembly 9 may be initially located in the raised position prior to installation of the wind turbine generator. The winch is used to lower the moveable connection assembly 9 as shown in FIG. 4, and the anchor secured to the seabed as shown in FIG. 5. Thereafter, if the need arises, the tension leg may be uncoupled from the anchor, and the remaining components of the moveable connection assembly raised as shown in FIG. 6, to, for example, allow maintenance of the yaw assembly above the water line. According to one aspect of the invention, tension leg 3 is provided with a buoyancy chamber 12 in the form of a hollow section of increased diameter that may be filled with air. The buoyancy chamber reduces the effective weight of the movable connection assembly and allows the use of a smaller winch than would otherwise be the case.

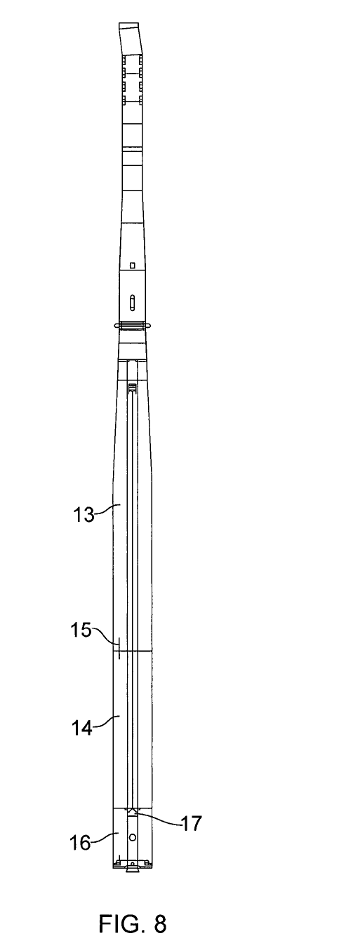

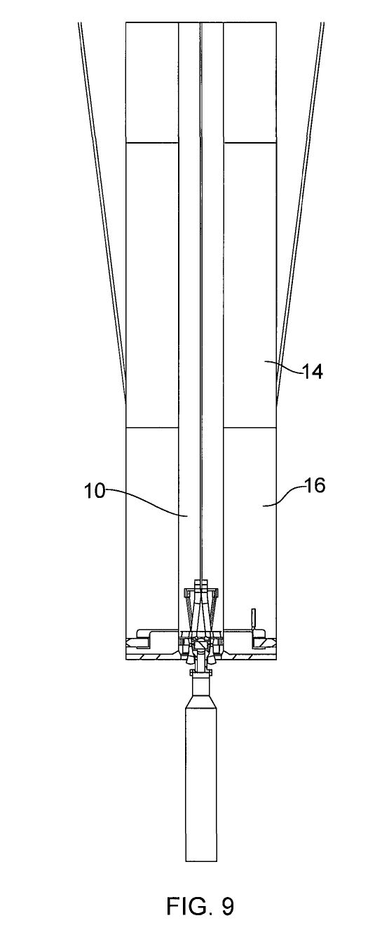

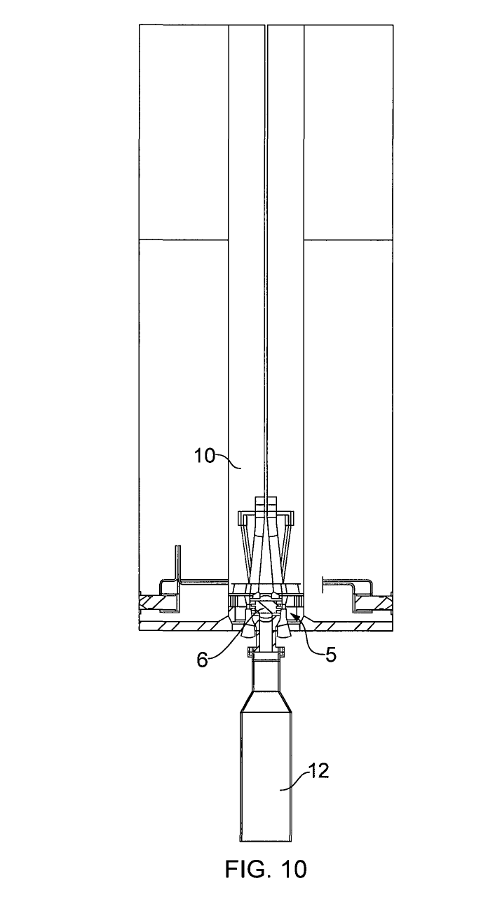

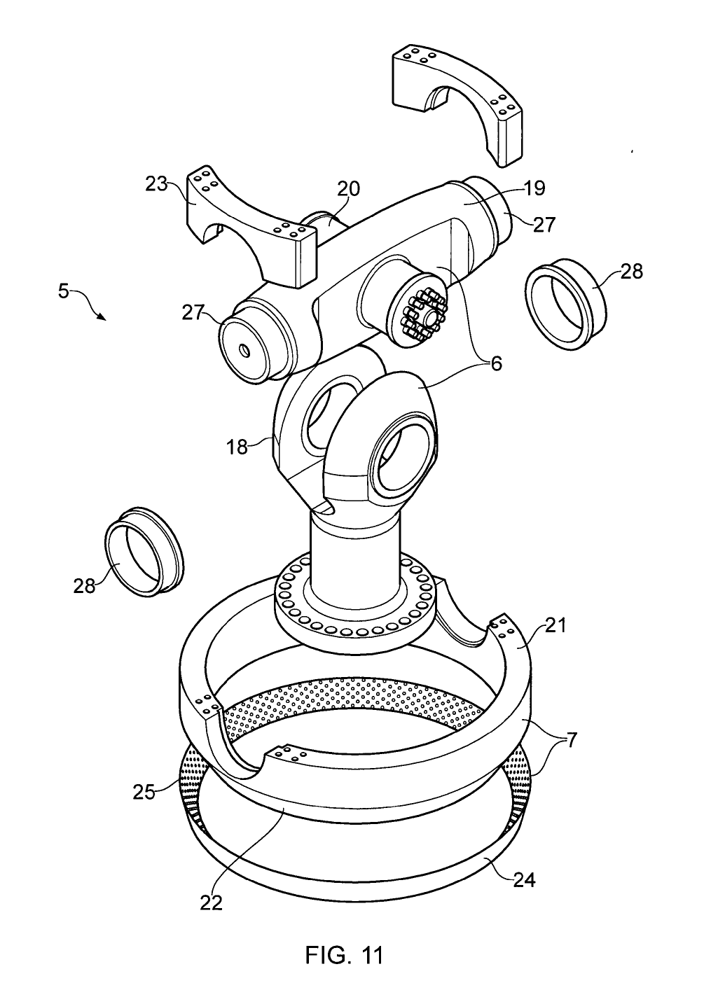

According to one aspect of the invention is provided a system and means for installation of the wind turbine generator at a location offshore. In some instances, it may be necessary to construct the wind turbine generator at a location where the water depth is shallower than the length of the tower. In such a case, the wind turbine generator will advantageously be towed horizontally or close to horizontally to its final destination, and then righted vertically, and secured to the seabed. According to one aspect of the invention, the tower is provided with both liquid and solid ballast. As shown in FIGS. 8 and 9, the tower comprises an upper ballast compartment 13 for water ballast alternatively this upper ballasting can be achieved with provisional internal or external ballasting). According to a preferred embodiment the upper water ballast compartment 13 may be located on one side of the tower. This, among other aspects, imparts stability to the tower on the surface of the water during the towing operation. The tower further comprises a lower water ballast compartment 14 connected to the upper ballast compartment 13 via a ballast water pipe 15 and pump (not shown). During the righting operation, water ballast is shifted from the upper compartment to the lower compartment. If the tower needs to be brought back to shore, the operation can be reversed.

The tower further comprises solid ballast in the form of sand, gravel, rocks, cement, steel scrap or the like located in a solid ballast compartment 16 at the lower end of the tower. Solid ballast compartment 16 is located in the annulus between the outer wall of the tower and the wall of the service tube 10. According to one aspect of the invention is provided a means for filling such solid ballast while the tower is in a vertical orientation. According to this aspect of the invention, openings are provided in the wall of the service tube leading to the solid ballast compartment. A removable plug 17 as seen in FIG. 8 or other removable obstruction/blockage is used to block the service tube immediately below the opening leading to the solid ballast chamber. The solid ballast may then be poured down the service tube, and will enter the solid ballast chamber. The plug or obstruction may advantageously have a sloping surface to more effectively lead the solid ballast into the chamber. After the solid ballast chamber is filled, the plug may be removed, and any residue will fall through the bottom of the service tube.

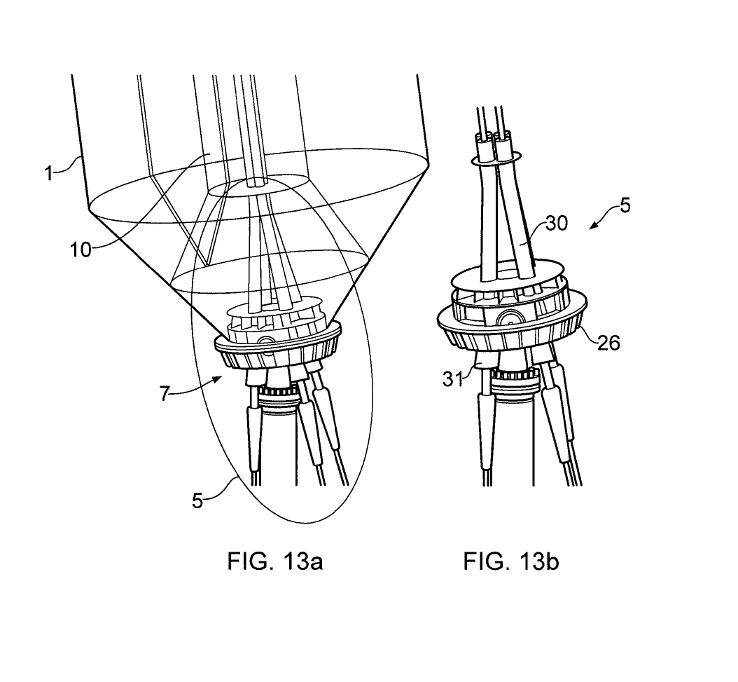

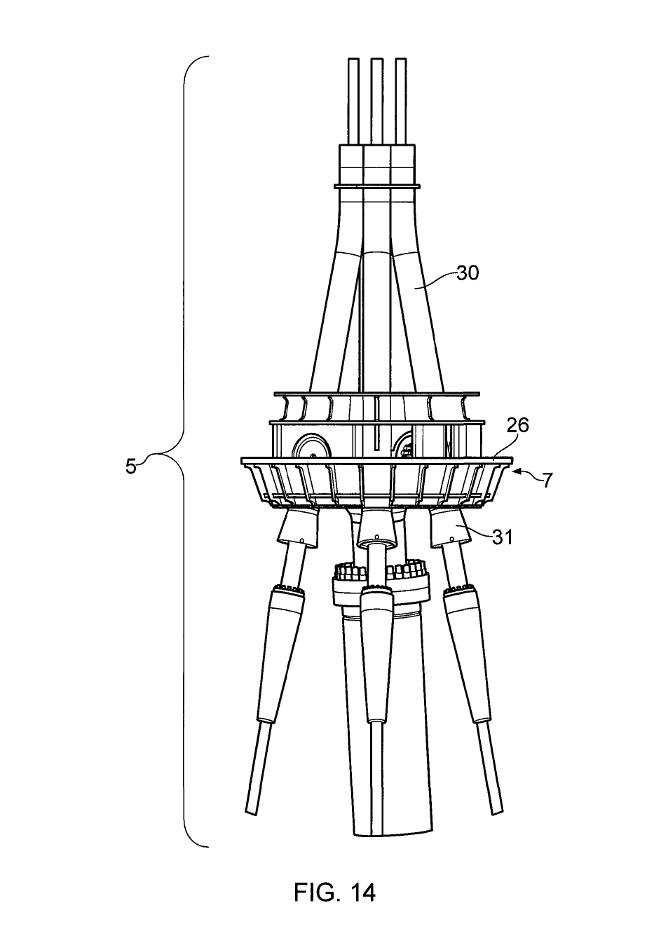

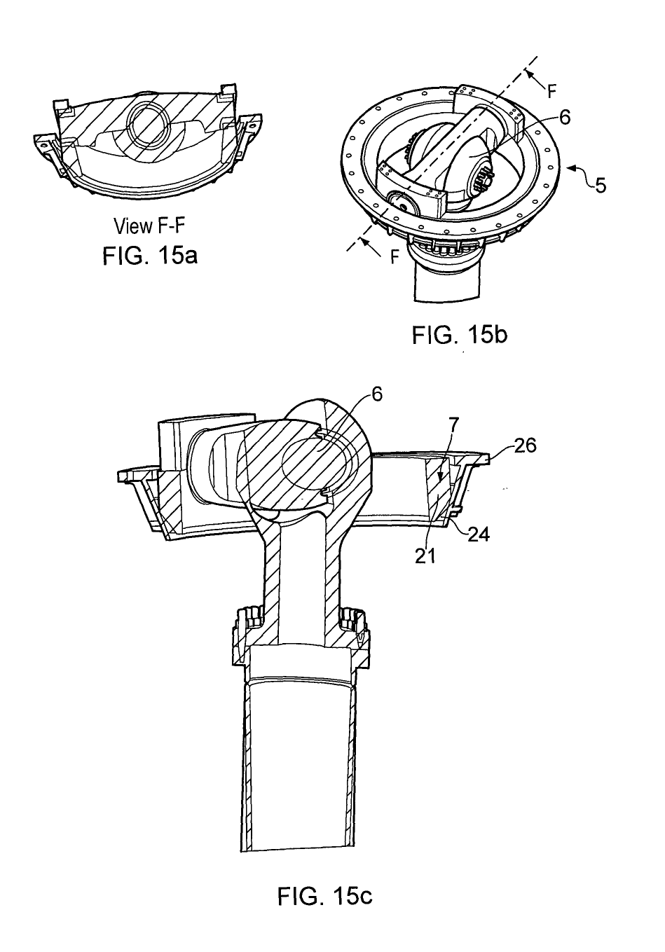

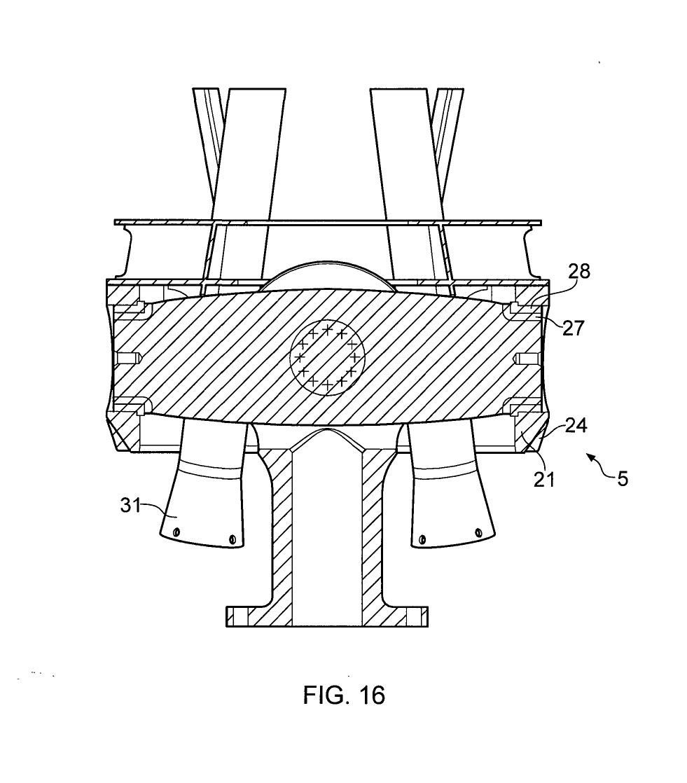

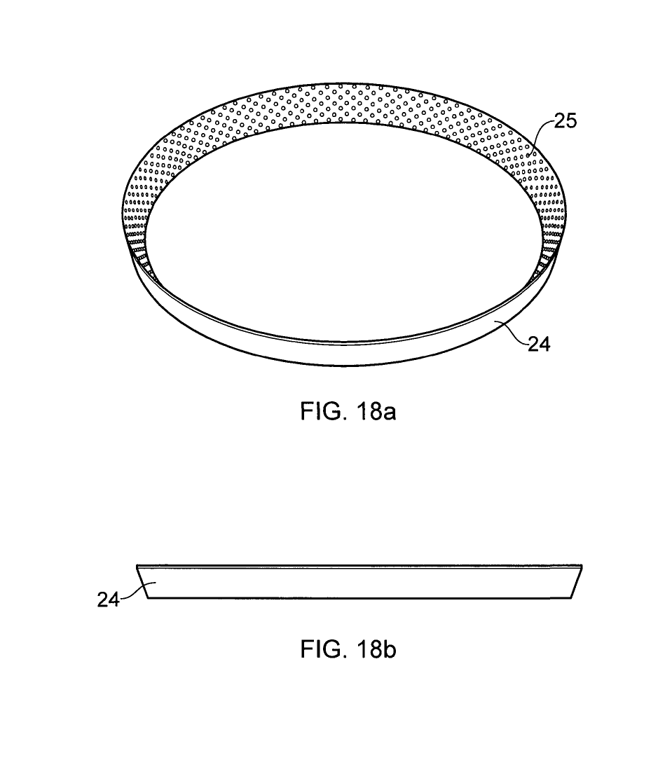

According to yet another aspect of the invention the upper connection assembly 5, comprises the yaw assembly 7 that permits the tower to oscillate and rotate about its axis and the upper universal joint 6. The yaw assembly will be described in reference to two different embodiments of the wind turbine generator tower; a first preferred embodiment having a flat lower end, and an embodiment of the tower having a conical lower end as shown in FIG. 13a, with components possibly common to both embodiments further shown in FIGS. 14-19. The yaw assembly 7 transfers the buoyancy load and a friction torque to the tension leg through a combination of a cone and a universal joint. The yaw system also includes penetrations and bells mouths to welcome the power cables.

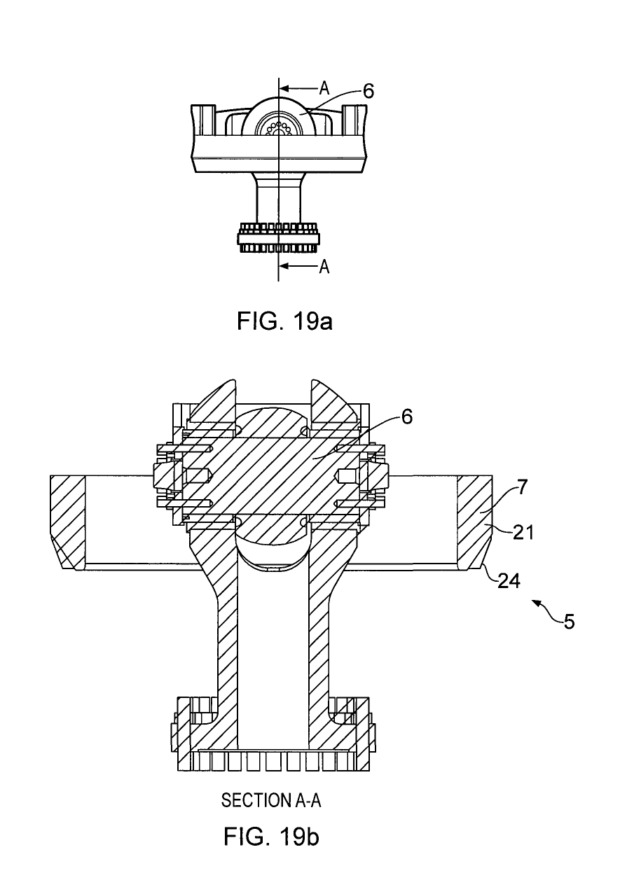

As shown in the figures, the upper universal joint 6 is attached to the tension leg 3 by a yoke 18. Upper universal joint 6 comprises a primary axis 19 and secondary axis 20. The primary axis 19 of the universal joint is connected to an annular support ring 21. Annular support ring 21 has a lower, angled bearing surface 22. The angle of the bearing surface is from 100 to 120 degrees. According to one aspect of the invention the angle is 110 degrees. A bearing cap 23 secures the primary axis to the annular support ring. The angled bearing surface 22 of the annular support ring 21 is arranged to slide against a friction ring 24 functioning as a plain bearing. Friction ring 24 has a wedged-shaped cross section as shown in FIG. 19. The friction ring is designed with a retainer ring so that it can be retrieved when the complete yaw system is pulled up to the surface within the service pipe.

According to one aspect of the invention, the angle of the front and back surfaces of the friction ring 24 are chosen such that a predetermined yaw friction is obtained. The two opposing faces of the wedge-shaped friction ring have different angles. The inner-facing surface (the surface against which the slanting surface of the ring-shaped element slides) has a greater degree of slope from vertical than the opposite surface (the surface abutting against the inside of the service tube or yaw-system receptacle). The difference in angles ensures that the wedge shaped member is pressed securely in place against the service tube, while allowing the ring-shaped element to slide against it. The reaction torque is carried by the tension/torsion leg down to the seabed via the fixed anchor. This arrangement results in a passive “clutch”, with the holding torque being a function of the net buoyancy of the tower (up-lift force when installed), the friction coefficient in the sliding surface, the angle to vertical of the wedged shaped member inner surface and the radius of the ring shaped element.

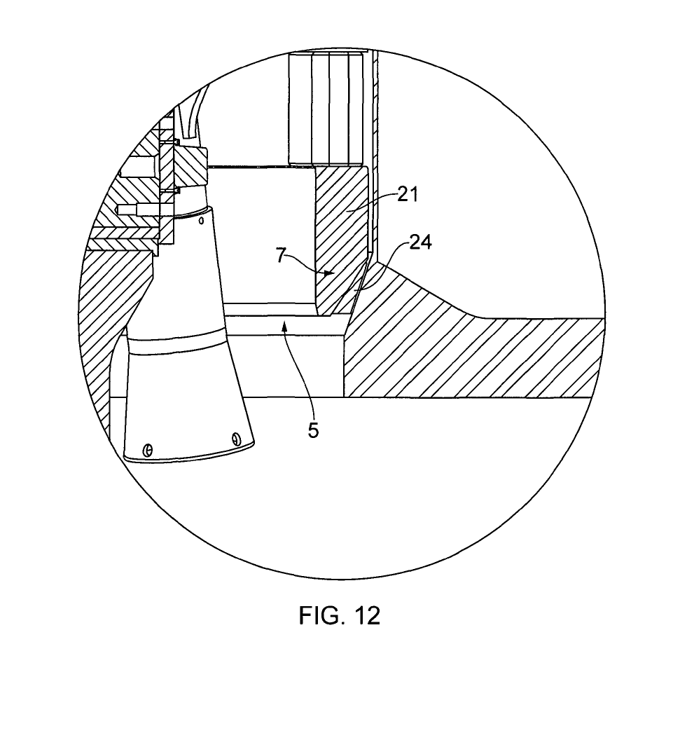

The friction ring is arranged either as shown in FIG. 12 at the lower end of service tube 10 according to one embodiment or alternatively arranged in a yaw system receptacle 26 connected to the lower end of the tower according to another embodiment as shown in 13a. The upper universal joint further comprises friction sleeves 27, bushings 28 and possibly a sacrificial anode 29, and axis stop plate 32.

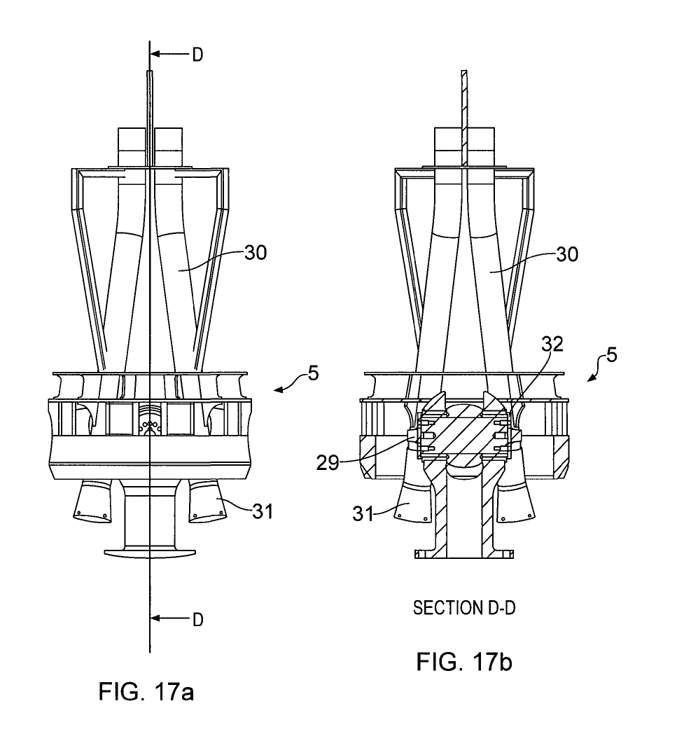

The upper connection assembly further comprises a power cable support frame 30 as shown in FIGS. 14 and 17, comprising a bell mouth 31 for receiving one or more power cables.

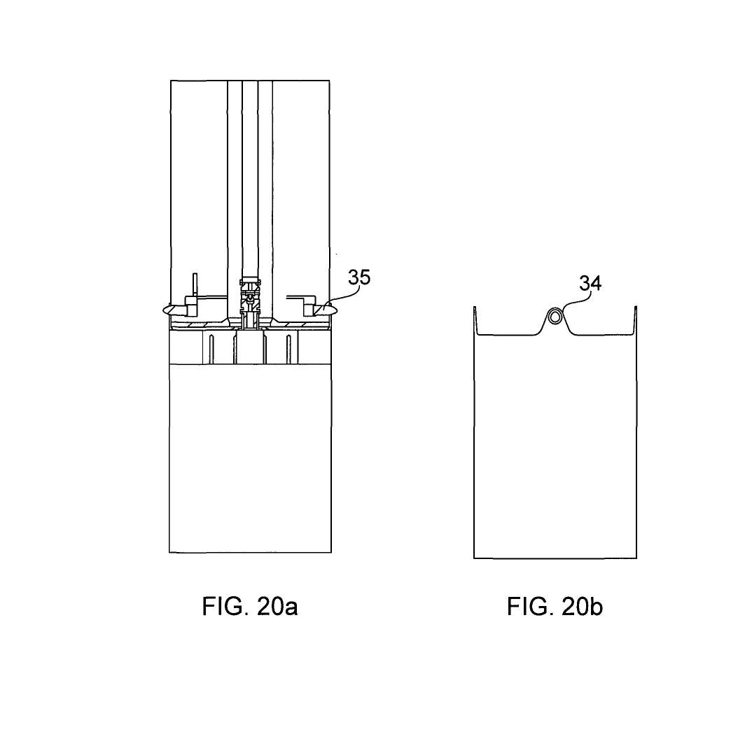

According to another aspect of the invention, the anchor is releasably attached to the tower, for example under transport of the wind turbine generator to its intended location. As shown in FIG. 20 the anchor according to this aspect is arranged with a similar diameter to the lower end of the tower. The upper end of the anchor is equipped with attachment rings 34. Inside the tower are mounted hydraulically actuated locking pins 35 that engage the attachment rings. The pins may thus be withdrawn to allow the anchor to be lowered into place.

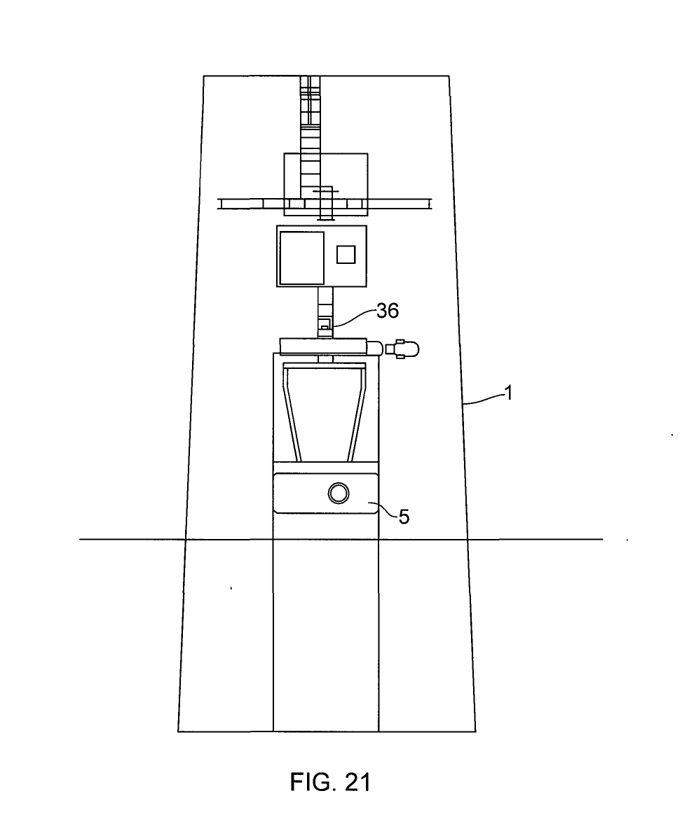

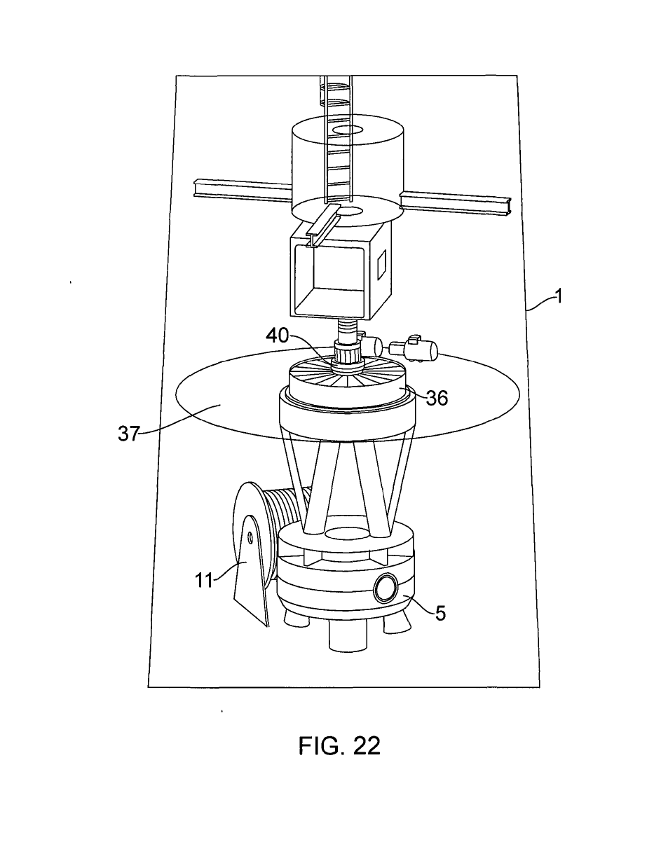

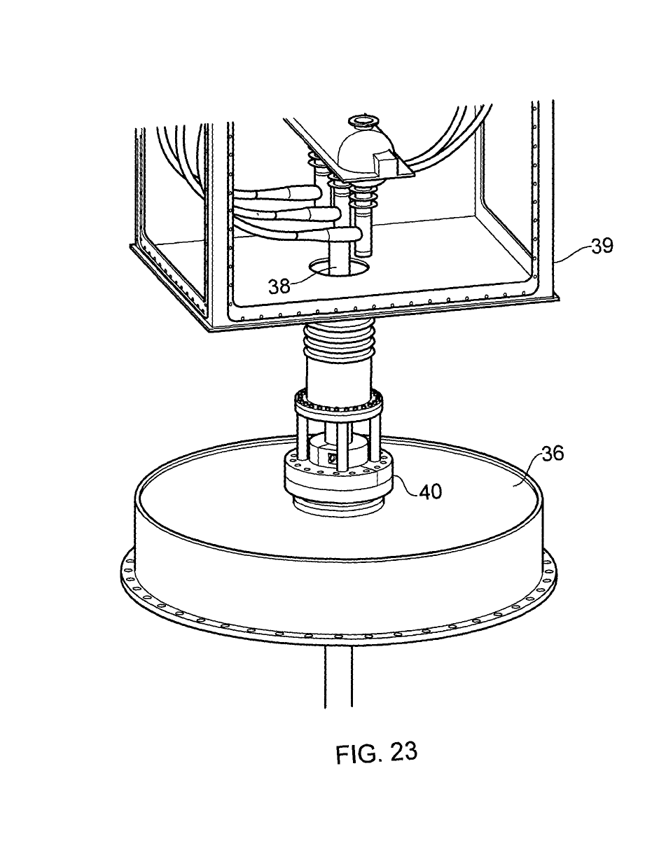

According to yet another aspect of the invention as shown in FIGS. 23 is provided a cable connection arrangement that permits the cables to remain stationary with respect to the seabed, while the tower is permitted to rotate/yaw about its axis. (It should be noted that FIGS. 21 and 22 show the yaw assembly in a raised position such as under transport/installation) The cable(s) 38 come up from the seabed in a cluster that enters the yaw assembly and are terminated in an electrical slip ring assembly 40, and are thus stationary with respect to the seabed. The electrical slip ring assembly transfers the electrical connection to the rotating tower, through a junction box 39 that is stationary with respect to the rotating tower. The cable connection towards the generator proceed through a cable hang-off member 36 affixed to a deck 37 at an upper end of the tower.

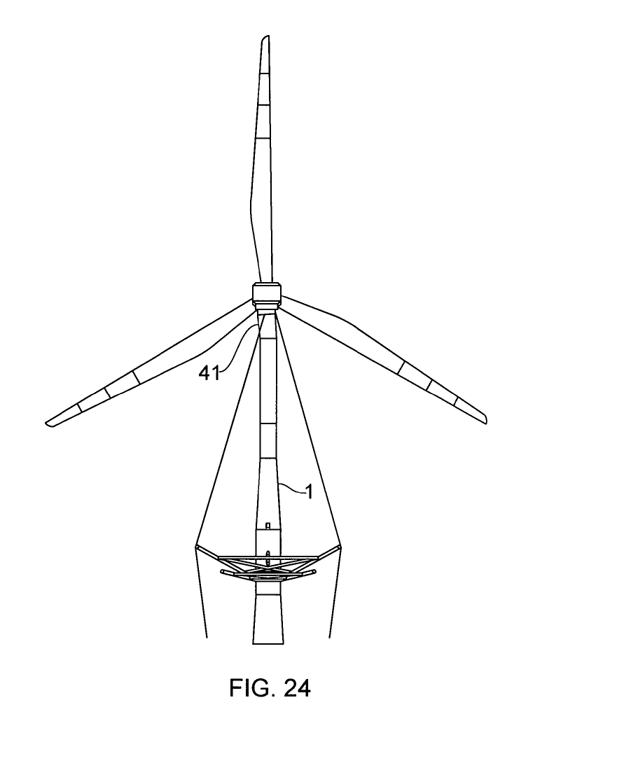

According to yet another aspect of the invention, as shown in FIG. 24, an upper segment 41 of the tower, directly adjacent to the attachment point for the turbine, is offset at an angle from the vertical axis of the tower. This offset is arranged to compensate for the yaw forces caused by the rotation of the turbine blades. Such yaw forces are due to the fact that the axis of the turbine shaft, which is transferring the torque from the rotor, and the axis of the tower are not perpendicular. This angle is typically some 4-6 degrees from being perpendicular. The effect is that some of the torque in the shaft will be transferred to the tower top as a torque component (or yawing moment) around the tower longitudinal axis. To compensate for this yawing moment the rotor is placed off axis of the tower so that the thrust forces acting on the rotor multiplied by the lever arm (the off axis distance) will create a yawing moment fully or partly counteracting the yaw moment component from the shaft torque. The effect is that the yaw moment caused by the shaft torque is fully or partly cancelled out and the holding torque in the yaw clutch at the bottom of the tower can be made with a smaller diameter. This also has the effect that the service pipe can be made of a smaller diameter to accommodate the clutch during hoisting of the connection arrangement for installation and maintenance purposes.

1. An offshore wind turbine generator comprising:
an elongated, buoyant tower having an internal service tube, the internal service tube extending from the lower end of the elongated, buoyant tower to above a waterline when in use;
a connection arrangement comprising an upper connection assembly and a lower connection assembly;
an intermediate tension/torsion leg being arranged between the upper and lower connection assemblies,
wherein the connection assembly is adapted for lowering and raising within the internal service tube.

2. The offshore wind turbine generator according to claim 1, wherein a winch is positioned in the elongated, buoyant tower for the lowering and raising of the connection assembly.

3. The offshore wind turbine generator according to claim 1, wherein the elongated, buoyant tower is substantially cylindrical.

4. The offshore wind turbine generator according to claim 1, where the lower connection assembly comprises a universal joint and an anchor connector.

5. The offshore wind turbine generator according to claim 4, further comprising an anchor having a coupling for receiving the anchor connector.

6. The offshore wind turbine generator according to claim 1, wherein the upper connection assembly comprises a yaw-arrangement.

7. The offshore wind turbine generator according to claim 6, wherein the upper connection assembly further comprises a universal joint.

8. The offshore wind turbine generator according to claim 1, wherein the connection arrangement has sufficient buoyancy to almost neutralize the weight in water of the connection arrangement so that only a small winch will be required during installation and maintenance.

9. The offshore wind turbine generator according to claim 5, the anchor is connected to the connection assembly during transport and installation of the wind turbine generator.

10. The offshore wind turbine generator according to claim 9, wherein the anchor is attached to the lower end of the elongated, buoyant tower by locking pins.

11. The offshore wind turbine generator according to claim 1, wherein the intermediate tension/torsion leg has an elongated portion of greater diameter in the form of an air, foam, or gas filled bouyancy chamber.

12. The offshore wind turbine generator according to claim 6, where the yaw arrangement is mounted at the lower end of the elongated, buoyant tower or service pipe.

13. The offshore wind turbine generator according to claim 6, where the yaw arrangement is mounted at the upper end of a service pipe.

14. An offshore wind turbine generator comprising:
an elongated buoyant tower; and
a connection assembly comprising a universal joint and yaw assembly,
wherein the universal joint and yaw assembly comprises a rocker arm and a ring-shaped member connected to the rocker arm.

15. The offshore wind turbine generator according to claim 14, wherein the ring-shaped member comprises a slanting lower circumferential surface arranged to rotatably seat against a wedge-shaped plain bearing.

16. The offshore wind turbine generator according to claim 14, further comprising a service tube wherein a plain bearing is located at a lower end of the service tube.

17. The offshore wind turbine generator according to claim 14, wherein two opposing faces of a wedge-shaped bearing have different angles to a vertical plane, an inner-facing surface having a greater degree of slope from the vertical plane than the outer-facing surface.

18. The offshore wind turbine generator according to claim 14, wherein cable conduits are arranged in a space between the ring-shaped member and the universal joint.

19. The offshore wind turbine generator according to claim 1, wherein electrical cables are connected to a swivel and an electrical slip ring connection at the upper end of a service tube

20. The offshore wind turbine generator according to claim 1, further comprising solid ballast or a combination of solid and water ballast.

21. The offshore wind turbine generator according to claim 20, comprising a ballast chamber at the lower end of the elongated, buoyant tower.

22. The offshore wind turbine generator according to claim 21, wherein there is arranged a removable blockage blocking the lower end of the service tube above the ballast chamber, and wherein there is arranged one or more openings in a wall of the service tube above the removable blockage.

23. The offshore wind turbine generator according to claim 22, wherein the removable blockage has a sloping upper surface.

24. A method for mounting an offshore wind turbine generator according to claim 1, the method comprising:
arranging solid ballast in the lower level of the tower;
arranging water ballast at an upper level of the tower during horizontal towing of the tower; and
righting the tower by shifting the water ballast to the lower level of the tower.

25. The method according to claim 24, wherein there is arranged a removable blockage blocking the lower part of the service tube above the ballast chamber, and wherein there is arranged one or more openings in the wall of the service tube above the blockage.

26. The method according to claim 25, wherein, after the solid ballast chamber is filled, the blockage is removed, so that any residue will fall through a bottom of the service tube.

27. The method according to one-of claim 24, wherein the solid ballast, such as sand or cement, is arranged in the tower while the tower is in a vertical orientation by pouring into a service tube, and allowed to fall toward a bottom of the tower.

28. An offshore wind turbine generator comprising:
an elongated, buoyant tower and a wind turbine mounted at a top of the tower,
wherein a upper end of the tower, adjacent to an attachment point for the wind turbine, is offset at an angle from a vertical axis of the tower.

29. The offshore wind turbine generator according to claim 28, comprising:
an internal service tube, the internal service tube extending from a lower end of the tower to above a waterline when in use;
a connection arrangement movably arranged within the internal service tube, the connection arrangement comprising:
an upper connection assembly, said upper connection assembly being arranged to rotatably seat in a lower end of the service tube,
a lower connection assembly,
an intermediate tension/torsion leg arranged between the upper and lower connection assemblies, and
a winch positioned in the tower for lowering and raising the connection assembly within the service tube.

30. An offshore wind turbine generator comprising an elongated, buoyant tower having a connection assembly comprising a universal joint and an anchor which is connected to the connection assembly during transport and installation of the wind turbine generator.
